(19) United States
(12) Patent Application Publication
(10) Pub. No.: US 2006/0146330 A1
(43) Pub. Date: Jul. 6, 2006

(54) Color measurements of ambient light

(76) Inventor: Selvan Maniam, Pulau Pinang (MY)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/029,613

(22) Filed: Jan. 4, 2005

(51) Int. Cl. G01J 3/51

(52) U.S. Cl. 356/405; 356/419

(57) ABSTRACT

A technique for measuring the color of ambient light involves a color sensor with color-specific interference filters and a diffuse reflecting surface that is configured to ensure that the ambient light is incident on the color-specific interference filters at the angle that produces optimal filtering. The diffuse reflecting surface causes reflected light to be spread evenly in the same direction relative to the diffuse reflecting surface regardless of the angle of incidence of the ambient light. The diffuse reflecting surface is oriented with respect to the color sensor to reflect the ambient light at the optimal filtering angle relative to the interference filters. Because of the diffuse reflecting surface, the ambient light is reflected to the interference filters at the optimal angle of incidence regardless of the angle at which the ambient light impacts the diffuse reflecting surface.

### BACKGROUND OF THE INVENTION

Color measurements of ambient light are typically made using a color sensor that includes color-specific filters (e.g., red, green, and blue filters) and a photodetector associated with each color-specific filter. Interference filters can be used in color sensors to provide the color-specific filtering. One drawback to interference filters is that they are sensitive to the angle of incidence of light and therefore, the performance of a color sensor can be significantly affected by the orientation of the color sensor relative to the ambient light. In some light sensor applications, the orientation of the sensor relative to ambient light is difficult to control.

The photodetectors of a color sensor produce output signals that are proportional to the intensity of the respective color of light. The output signals are typically converted into standard colorspace coordinates (e.g., the Commission Internationale de l'Eclairage (CIE) XYZ colorspace coordinates). The conversion process usually involves a linear mapping to the standard colorspace coordinates. However, linear mapping suffers from limited degrees of freedom, which limits the accuracy of the color measurement.

### SUMMARY OF THE INVENTION

A technique for measuring the color of ambient light involves a color sensor with color-specific interference filters and a diffuse reflecting surface that is configured to ensure that the ambient light is incident on the color-specific interference filters at the angle that produces optimal filtering. The diffuse reflecting surface causes reflected light to be spread evenly in the same direction relative to the diffuse reflecting surface regardless of the angle of incidence of the ambient light. The diffuse reflecting surface is oriented with respect to the color sensor to reflect the ambient light at the optimal filtering angle of incidence relative to the interference filters. Because of the diffuse reflecting surface, the ambient light is reflected to the interference filters at the optimal angle of incidence regardless of the angle at which the ambient light impacts the diffuse reflecting surface. The diffuse reflecting surface in effect reduces the sensitivity of the color measurement system to changes in the angle of incidence of the ambient light. In one embodiment, the color-specific interference filters are configured to mimic the response of the human eye.

In an embodiment, polynomial algorithms are used to convert the digital output signals to standard CIE colorspace coordinates. The order of the polynomial used in the conversion can be of the n^{th} order, where n is greater than one. When using a polynomial algorithm, a coefficient matrix must first be determined so that the color sensor output signals can be converted to CIE colorspace coordinates (XYZ). Techniques for determining the coefficient matrix may include 1) purely empirical, 2) purely mathematical, and 3) a combination of empirical and mathematical. One technique for determining the coefficient matrix involves integrating the product of stored spectral data and sensor response data to generate output signal values (i.e., RGB values) and integrating the product of a color matching function and the stored set of spectral data to generate a set of standard colorspace coordinates (i.e., XYZ values). The RGB values and XYZ values are then used to calculate the coefficient matrix.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a color measurement system that is configured to measure the color of ambient light in accordance with an embodiment of the invention.

FIG. 2 depicts an expanded view of the color measurement processor from FIG. 1, which includes coefficient matrix logic and color conversion logic.

FIG. 3 depicts an example of the RGB spectral response curves of a color sensor.

FIG. 4 depicts an embodiment of a color measurement system that includes an isolating structure that isolates the color sensor from portions of the ambient light in accordance with an embodiment of the invention.

FIG. 5 depicts a process flow diagram of a method for measuring the color of ambient light in accordance with the invention.

Throughout the description similar reference numbers may be used to identify similar elements.

### DETAILED DESCRIPTION

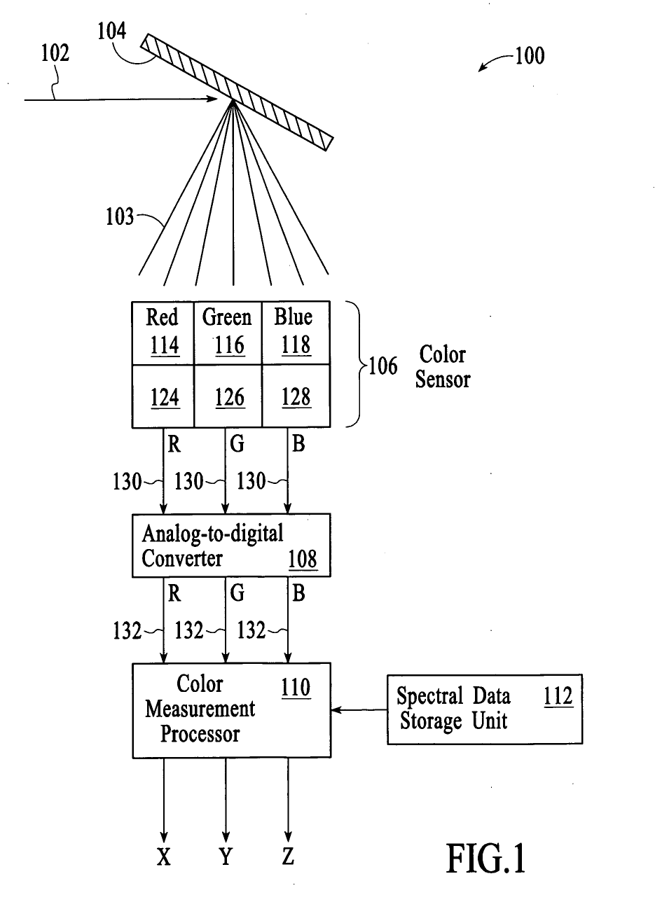

FIG. 1 depicts a color measurement system 100 that is configured to measure the color of ambient light 102. The color measurement system includes a diffuse reflecting surface 104, a color sensor 106, an analog-to-digital converter 108, a color measurement processor 110, and a spectral data storage unit 112.

The color sensor 106 includes color-specific filters 114, 116, and 118 and a photodetector 124, 126, and 128 associated with each filter. The color-specific filters are bandpass filters that are configured to filter different bands of the visible spectrum. In the embodiment of FIG. 1, the color-specific filters consist of a red filter, a blue filter, and a green filter. The red filter passes light in the red spectrum, the blue filter passes light in the blue spectrum, and the green filter passes light in the green spectrum. In an embodiment, the color-specific filters are color-specific interference filters. The color-specific interference filters can be configured to exhibit filtering characteristics that mimic the response of the human eye, other color matching fuctions (CMF) such as the CIE standard CMF, or functions derived from the CIE standard CMF. One drawback to interference filters is their sensitivity to the angle of incidence of light. That is, light must be incident on interference filters at a specific angle to achieve optimal filtering. As is described below, the diffuse reflecting surface 104 is utilized to ensure that at least a portion of the ambient light is incident on the color-specific interference filters at the angle that produces optimal filtering.

The photodetectors 124, 126, and 128 of the color sensor 106 can be any photosensitive devices that produce output signals in proportion to the intensity of the incident light. In the embodiment of FIG. 1, the photodetectors are photodiodes that are integrated into an integrated circuit (IC) chip.

The diffuse reflecting surface 104 is configured to diffuse and reflect ambient light. The diffuse reflecting surface causes reflected light 103 to be spread evenly in the same direction relative to the diffuse reflecting surface regardless of the angle of incidence of the ambient light. In a preferred embodiment, the diffuse reflecting surface is oriented with respect to the color sensor 106 to reflect the ambient light at the optimal angle of incidence relative to the interference filters. Therefore, the ambient light is reflected to the interference filters 114, 116, and 118 at the optimal filtering angle regardless of the angle at which the ambient light impacts the diffuse reflecting surface. The diffuse reflecting surface in effect reduces the sensitivity of the color measurement system to changes in the angle of incidence of the ambient light 102. In an embodiment, the diffuse reflecting surface is a non-glossy white surface. Although a non-glossy white surface is described, other diffuse reflecting surfaces are possible.

The analog-to-digital converter 108 converts analog output signals 130 from the color sensor 106 to digital output signals 132. In an embodiment, the analog output signals are converted to 8-bit digital values. Although 8-bit digital values are used herein, other width digital values are possible.

The color measurement processor 110 manages the conversion of the digital output signals to standard colorspace coordinates. The digital output signals 132 can be converted to any standard coordinate system including, for example, the CIE XYZ colorspace coordinate system. In an embodiment, polynomial algorithms are used to convert the digital output signals to standard colorspace coordinates. The order of the polynomial used in the conversion can be of the n^{th} order, where n is greater than one. For illustrative purposes, the output signals from a three channel RGB color sensor are converted to CIE XYZ colorspace coordinates using second order polynomials. In the example, the digital output signals from the analog-to-digital converter 108 of the color measurement system 100 are represented by “R” for red, “G” for green, and “B” for blue. The general equation for converting the digital output signals to the CIE XYZ colorspace coordinates using a second order polynomial is given by:

$$( \begin{matrix}X \\ Y \\ Z\end{matrix} ) = ( \begin{matrix}{a}_{1} {a}_{2} {a}_{3} {a}_{4} {a}_{5} {a}_{6} \\ {b}_{1} {b}_{2} {b}_{3} {b}_{4} {b}_{5} {b}_{6} \\ {c}_{1} {c}_{2} {c}_{3} {c}_{4} {c}_{5} {c}_{6}\end{matrix} ) \cdot ( \begin{matrix}R \\ G \\ B \\ {R}^{2} \\ {G}^{2} \\ {B}^{2}\end{matrix} )$$

The coefficient matrix,

$$( \begin{matrix}{a}_{1} {a}_{2} {a}_{3} {a}_{4} {a}_{5} {a}_{6} \\ {b}_{1} {b}_{2} {b}_{3} {b}_{4} {b}_{5} {b}_{6} \\ {c}_{1} {c}_{2} {c}_{3} {c}_{4} {c}_{5} {c}_{6}\end{matrix} ) ,$$

must first be determined so that the digital output signals (RGB) can be converted to colorspace coordinates (XYZ).

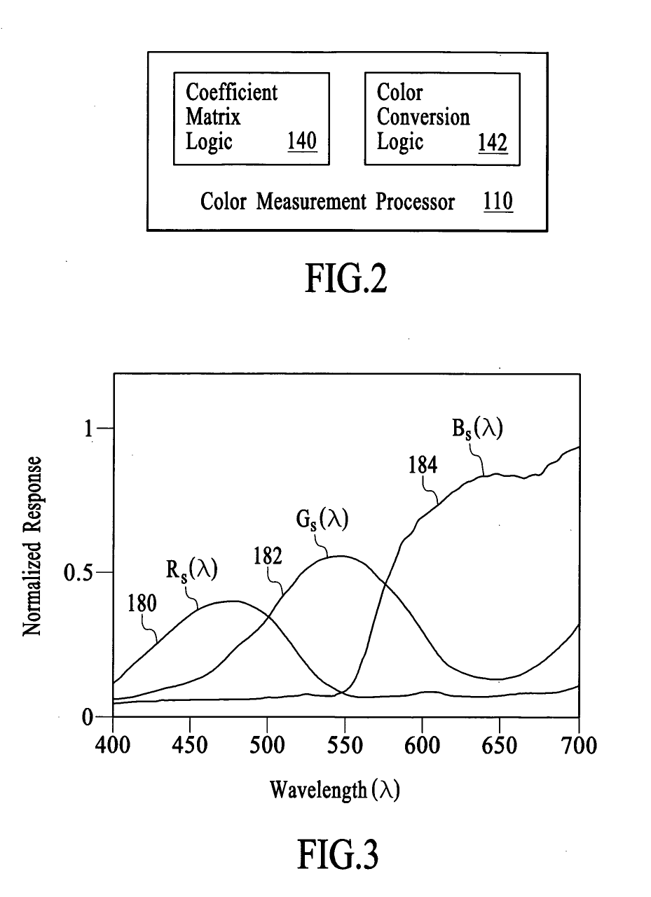

In an embodiment, the color measurement processor 110 includes coefficient matrix logic 140 and color conversion logic 142 as depicted in FIG. 2. The coefficient matrix logic manages the calculation of the coefficient matrix and the color conversion logic uses the coefficient matrix to convert the digital output signals to standard colorspace coordinates.

The coefficient matrix determined by the coefficient matrix logic 140 is unique to the specific color sensor and is dependent on the spectral response of the color sensor. Techniques for determining the coefficient matrix may include 1) purely empirical, 2) purely mathematical, and 3) a combination of empirical and mathematical. A purely empirical technique involves providing light of known colors (e.g., known XYZ colorspace coordinates) to the color measurement system and taking color measurements (e.g., values for Rₙ, Gₙ, Bₙ). For example, n different samples of light are provided and n different color measurements are made. The coefficient matrix is then determined in response to the color measurements.

A purely mathematical technique involves providing a stored set of spectral data to the coefficient matrix logic 140 from, for example, the spectral data storage unit 112. The stored set of spectral data can correspond to responses from different color light sources or the spectral data can be artificially generated (e.g., manually or by computer). For example, the set of spectral data includes n different spectrums. The spectral response of the color sensor is also provided to the coefficient matrix logic. The spectral response of an RGB sensor can be identified as a function of wavelength by the color-specific functions Rₛ(λ) Gₛ(λ), and Bₛ(λ). FIG. 3 depicts an example of the RGB spectral response curves 180, 182, and 184 of a color sensor. With the stored set of spectral data and the spectral response of the color sensor, digital output signals (e.g., Rₙ, Gₙ, Bₙ) can be mathematically obtained by performing an integration of the product between the spectral data and the appropriate sensor response curve over the entire visible spectrum. Corresponding CIE XYZ colorspace coordinates (e.g., Xₙ, Yₙ, Zₙ) can then be calculated by integrating the product between the appropriate CMF and the stored set of spectral data. With the calculated values of the digital output signals (e.g., Rₙ, Gₙ, Bₙ) and the CIE XYZ colorspace coordinates (e.g., Xₙ, Yₙ, Zₙ), the matrix equation from above can be solved to determine the coefficient matrix. An advantage of the purely mathematical technique is that no extra equipment (e.g., light sources of known color or a CIE camera that is used to measure the color of light) is needed to determine the coefficient matrix of the color sensor. Additionally, in the event that the color sensor needs to be replaced, the color measurement system can be recalibrated by simply providing the spectral response of the replacement color sensor to the spectral data storage unit and performing the above-described steps.

The coefficient matrix can alternatively be determined utilizing a combination of a stored set of spectral data and empirical data obtained in response to a known light source. Using this technique, values for Rₙ, Gₙ, and Bₙ are pulled from both stored spectral data and from empirical data. The combination of values is used to calculate the coefficient matrix as described above.

Whether the coefficient matrix is determined using a purely empirical technique, a purely mathematical technique, or a combination thereof, the coefficient matrix is used by the color conversion logic 142 to convert digital output signals to standard colorspace coordinates. For example, the color conversion logic converts digital output signals from the analog-to-digital converter to CIE XYZ colorspace coordinates.

Operation of the color measurement system 100 to measure the color of ambient light is now described with reference to FIG. 1. After the coefficient matrix is determined as described above, the color measurement system is exposed to the ambient light 102 that is to be measured. In particular, the color measurement system is oriented such that the ambient light to be measured is incident on the diffuse reflecting surface 104. The ambient light that is incident on the diffuse reflecting surface is reflected to the interference filters 114, 116, and 118 of the color sensor at the optimal angle for filtering. The light that is incident on the color-specific interference filters is filtered. The filtered light is detected by the photodetectors 124, 126, and 128 associated with each color-specific filter and analog output signals 130 are generated in response to the filtered light. The output signals are provided to the analog-to-digital converter 108, where they are converted to digital output signals 132. The digital output signals are provided to the color measurement processor 110. The color measurement processor then converts the digital output signals to standard colorspace coordinates, such as the CIE XYZ colorspace coordinates, using the coefficient matrix as described above.

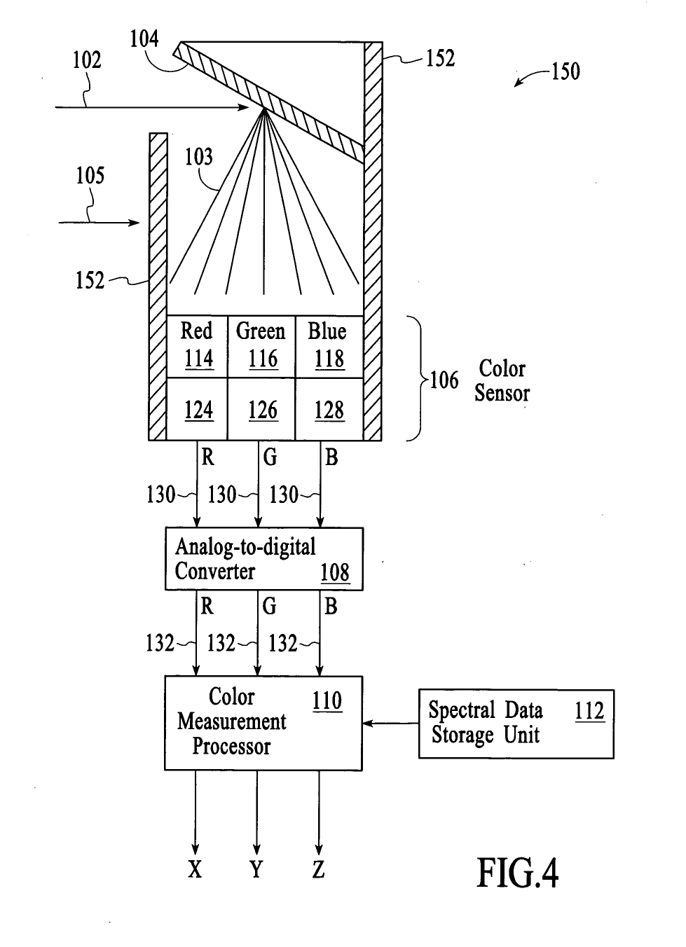

In some applications, it is desirable to better control access of ambient light to the color sensor. FIG. 4 depicts an embodiment of a color measurement system 150 that includes an isolating structure 152 that isolates the color sensor 106 from portions of the ambient light 102. In this example, the isolating structure isolates the color sensor 106 from ambient light 105 that is not reflected off of the diffuse reflecting surface 104. In the embodiment of FIG. 4, the isolating structure is an opaque structure that surrounds the color sensor. For example, the opaque structure includes a vertical wall or walls that prevent ambient light from directly impacting the color sensor. In the embodiment of FIG. 4, the diffuse reflecting surface is directly connected to the isolating structure.

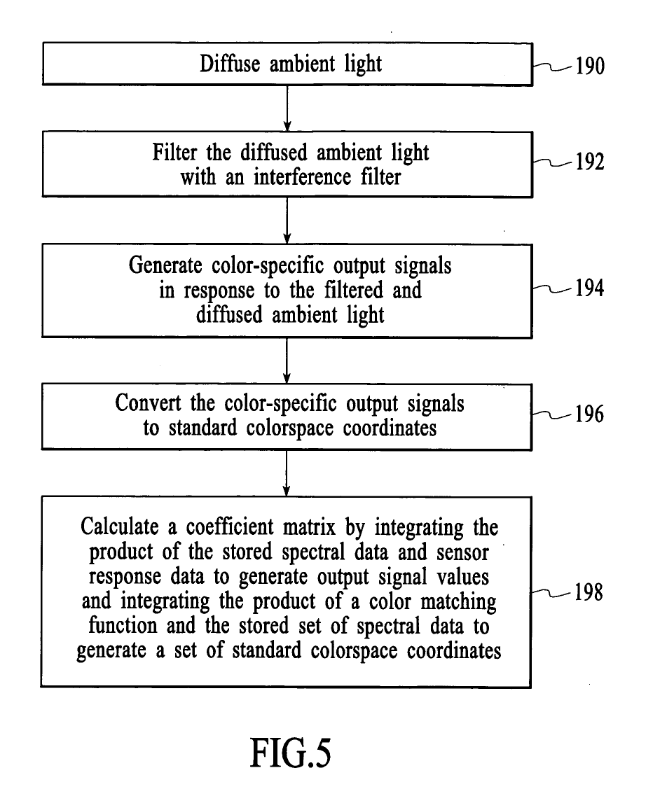

FIG. 5 depicts a process flow diagram of a method for measuring the color of ambient light in accordance with the invention. At block 190, ambient light is diffused. At block 192, the diffused ambient light is filtered with an interference filter. At block 194, color-specific output signals are generated in response to the filtered and diffused ambient light. At block 196, the color-specific output signals are converted to standard colorspace coordinates. At block 198, converting the color-specific output signals to standard colorspace coordinates includes calculating a coefficient matrix by integrating the product of the stored spectral data and sensor response data to generate output signal values and integrating the product of a color matching function and the stored set of spectral data to generate a set of standard colorspace coordinates.

The above-described systems and methods can be applied to color sensors that have more or less channels than a three-channel RGB color sensor. Further, the color spectrums measured by the color sensor could be other than RGB. Although the CIE colorspace coordinates are described as the standard colorspace coordinates, other colorspace coordinate systems could be used.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A system for measuring the color of ambient light comprising:
a color sensor configured to generate color-specific output signals in response to incident light, the color sensor including color-specific interference filters; and
a diffuse reflecting surface configured to reflect ambient light towards the color sensor.

2. The system of claim 1 wherein the color-specific interference filters are configured to mimic the response of the human eye.

3. The system of claim 1 wherein the color-specific interference filters have an optimal filtering angle and wherein the diffuse reflecting surface is configured to reflect ambient light towards the color sensor at the optimal filtering angle.

4. The system of claim 3 further including an isolating structure configured to isolate the color sensor from ambient light that is not reflected from the diffuse reflecting structure.

5. The system of claim 4 wherein the isolating structure includes an opaque structure that is configured to block ambient light from impacting the color sensor without first being reflected off of the diffuse reflecting structure.

6. The system of claim 1 further including an analog-to-digital converter configured to convert the color-specific output signals to digital color-specific output signals and a color measurement processor configured to convert the digital color-specific output signals to standard colorspace coordinates.

7. The system of claim 6 wherein the standard colorspace coordinates are CIE XYZ coordinates and wherein the color sensor is a red, greed, and blue color sensor.

8. The system of claim 6 wherein the color measurement processor includes coefficient matrix logic that is configured to calculate a coefficient matrix using a stored set of spectral data.

9. The system of claim 8 wherein the coefficient matrix logic is configured to integrate the product of the stored spectral data and sensor response data to generate output signal values and to integrate the product of a color matching function and the stored set of spectral data to generate a set of standard colorspace coordinates and to calculate the coefficient matrix using the output signal values and the set of standard colorspace coordinates.

10. The system of claim 6 wherein the color measurement processor includes coefficient matrix logic that is configured to calculate a coefficient matrix using a stored set of spectral data and color measurements from light of a known color.

11. A method for measuring the color of ambient light comprising:
diffusing ambient light;
filtering the diffused ambient light with an interference filter;
generating color-specific output signals in response to the filtered and diffused ambient light; and
converting the color-specific output signals to standard colorspace coordinates.

12. The method of claim 11 further including isolating the diffused ambient light from other non-diffused ambient light.

13. The method of claim 11 wherein converting the color-specific output signals to standard color coordinates includes using polynomial transforms.

14. The method of claim 13 wherein converting the color-specific output signals to standard color coordinates includes calculating a coefficient matrix using a stored set of spectral data.

15. The method of claim 14 wherein converting the color-specific output signals to standard colorspace coordinates includes calculating a coefficient matrix by integrating the product of the stored spectral data and sensor response data to generate output signal values, integrating the product of a color matching function and the stored set of spectral data to generate a set of standard colorspace coordinates, and calculating the coefficient matrix using the output signal values and the set of standard colorspace coordinates.

16. The method of claim 13 wherein converting the color-specific output signals to standard color coordinates includes calculating a coefficient matrix using a stored set of spectral data and color calibration measurements.

17. A system for measuring the color of ambient light comprising:
a color sensor configured to generate color-specific output signals in response to incident light, the color sensor including color-specific interference filters;
a diffuse reflecting surface configured to reflect ambient light towards the color sensor;
an isolating structure configured to isolate the color sensor from ambient light that is not reflected from the diffuse reflecting structure;
an analog-to-digital converter configured to convert the color-specific output signals from the color sensor to digital color-specific output signals; and
a color measurement processor configured to convert the digital color-specific output signals to standard colorspace coordinates.

18. The system of claim 17 wherein the color-specific interference filters have an optimal filtering angle and wherein the diffuse reflecting surface is configured to reflect ambient light towards the color sensor at the optimal filtering angle.

19. The system of claim 18 wherein the color measurement processor includes coefficient matrix logic that is configured to calculate a coefficient matrix using a stored set of spectral data.

20. The system of claim 19 wherein the coefficient matrix logic is configured to integrate the product of the stored spectral data and sensor response data to generate output signal values and to integrate the product of a color matching function and the stored set of spectral data to generate a set of standard colorspace coordinates and to calculate the coefficient matrix using the output signal values and the set of standard colorspace coordinates.
